(19) United States
(12) Patent Application Publication
(10) Pub. No.: US 2024/0293861 A1
(43) Pub. Date: Sep. 5, 2024

(54) CONDITIONED METAL PARTICLES FOR THREE-DIMENSIONAL PRINTING

(71) Applicant: Hewlett-Packard Development Company, L.P., Spring, TX (US)

(72) Inventors: David R. Otis, Jr., Corvallis, OR (US); Vladek Kasperchik, Corvallis, OR (US); Mohammed Shaarawi, Corvallis, OR (US)

(21) Appl. No.: 18/575,195

(22) PCT Filed: Jul. 9, 2021
(86) PCT No.: PCT/US2021/041062

§ 371 Date: Dec. 28, 2023

(51) Int. Cl. B22F 1/14; B22F 1/052; B22F 1/065; B22F 10/14; B33Y 10/00; B33Y 30/00; B33Y 40/10

(52) U.S. Cl. CPC B22F 1/14; B22F 1/052; B22F 1/065; B22F 10/14; B33Y 10/00; B33Y 30/00; B33Y 40/10

(57) ABSTRACT

Methods of preparing a particulate build material for three-dimensional printing can include loading fresh particulate build material including from about 80 wt % to 100 wt % fresh metal particles into a mechanical mixer, and mechanically conditioning the fresh particulate build material to generate conditioned particulate build material including conditioned metal particles. The fresh metal particles can have a surface oxide layer, and the fresh particulate build material can have a particle size distribution with a D10 particle size from about 2 μm to about 10 μm, a D50 particle size from about 5 μm to about 20 μm, and a D90 particle size from about 20 μm to about 40 μm. The conditioned particulate build material can include a modified cohesive index (compared to the fresh conditioned particulate build material) ranging from about 25 cohesive index units to about 35 cohesive index units.

### BACKGROUND

Three-dimensional (3D) printing is an additive printing process used to make three-dimensional solid parts or objects from a digital model. Three-dimensional printing is used in rapid product prototyping, mold generation, mold master generation, short run manufacturing, etc. Some three-dimensional printing techniques are considered additive processes because they involve the application of successive layers of build material. This is unlike some machining processes, which rely on the removal of material to create a part. Some three-dimensional printing methods involve fusing or melting of build material particles together. For example, melting or partial melting of build material particles may be carried out using heat-assisted extrusion, or in other examples, particles can be heat fused together either at the location of a build or can be moved to a heating device or oven.

### BRIEF DESCRIPTION OF THE DRAWINGS

FIG. 1 is a flow diagram illustrating example methods of preparing conditioned particulate build material for three-dimensional printing in accordance with the present disclosure;

FIG. 2 is a flow diagram illustrating example methods of three-dimensional printing using the conditioned particulate build material prepared in accordance with FIG. 1; and

FIG. 3 is a schematic illustration of example systems useable for three-dimensional printing in accordance with the present disclosure.

### DETAILED DESCRIPTION

In some methods and systems, three-dimensional printing is an additive process involving the application of successive layers of a particulate build material with a binding agent printed thereon to build up and bind successive layers of the particulate build material together. Areas where the particulate build material is not contacted with the binding agent do not form part of the printed object, but instead can act to support subsequently printed layers during a three-dimensional object build. During the printing process, the binding agent is selectively applied to a layer of particulate build material on a build platform to pattern a selected region of the layer. The binding agent is capable of penetrating the layer of the particulate build material onto which it is applied, often filling void spaces between metal particles of the particulate build material. This is repeated layer-by-layer until a green body object is formed. The green body object is then moved to a sintering oven, or another heating device, to heat fuse or sinter the particulate build material of the green body object together and form a heat-fused metal three-dimensional object.

### Methods of Preparing Particulate Build Material for Three-dimensional Printing

Methods of preparing a particulate build material for three-dimensional printing 100 are illustrated in FIG. 1 and include loading 110 fresh particulate build material including from about 80 wt % to 100 wt %, from about 90 wt % to 100 wt %, from about 95 wt % to 100 wt %, or about 100 wt % fresh metal particles into a mechanical mixer, and mechanically conditioning 120 the fresh particulate build material to generate conditioned particulate build material including conditioned metal particles. The fresh metal particles prior to conditioning typically include a surface oxide layer, which can be initially removed or partially removed during the conditioning using the mechanical mixer.

The fresh particulate build material has a particle size distribution with a D10 particle size from about 2 μm to about 10 μm, a D50 particle size from about 5 μm to about 20 μm, and a D90 particle size from about 20 μm to about 40 μm. In some examples, the particle size distribution can exhibit a D10 particle size from about 3 μm to about 8 μm, a D50 particle size from about 8 μm to about 15 μm, and a D90 particle size from about 22 μm to about 35 μm. The particle size distribution of the particulate build material and/or metal particles may exhibit a Gaussian-like distribution curve, or may be non-Gaussian. Gaussian-like distribution curves are slightly skewed in one direction or the other (toward the smaller end or toward the larger end of the particle size distribution range). An example Gaussian-like distribution may be characterized with “D10,” “D50,” and “D90” particle size distribution values, where D10 refers to the particle size at the 10^{th} percentile. D50 refers to the particle size at the 50^{th} percentile, and D90 refers to the particle size at the 90^{th} percentile. It is noted that individual particle sizes may be outside of these ranges. A “D50 particle size” indicates the particle size at which half of the particles are larger than the D50 particle size and the other half of the particles are smaller than the D50 particle size. Particle sizes for the particulate build material distribution including the metal particles thereof are volume-weighted particles sizes (or particle size distribution by volume) that can be determined using a high resolution scanning electron microscope. For example, particle size distribution analysis may include using an optical image analysis tool, such as a Camsizer X2 from Microtrac MRB (Japan).

The metal particles can include at least one of an elemental metal or alloy of iron, chromium, nickel, titanium, steel, stainless steel, carbon steel, cast iron, or wrought iron. In other examples, the metal particles can include stainless steel. The metal particles may be gas atomized particles, for example, and may have any of a number of morphologies, including spherical, non-spherical, or a combination of both. The aspect ratio of spherical particles is defined as ranging from about 1:1 to about 1:1.1. Non-spherical nanoparticles are defined as being from greater than about 1:1.1 to about 1:4, for example. In some examples, the fresh metal particles used to form the conditioned metal particles may be gas atomized spherical metal particles, such as gas atomized spherical stainless steel metal particles.

The conditioned particulate build material has a modified cohesive index (compared to the fresh conditioned particulate build material) ranging from about 25 cohesive index units to about 35 cohesive index units. In some examples, the conditioned particulate build material can have a modified cohesive index ranging from about 25 to about 30, from about 30 to about 35, or from about 27 to about 33 cohesive index units. Mechanically conditioning the fresh particulate build material burnishes a surface of the fresh metal particles, which may include metal oxide nodules at the surface. For example, vigorous mechanical mixing or conditioning causes multiple collisions and friction between individual particles, resulting in removal of the nodules and other surface asperities that may be present. This process can thus alter the inter-particle attractions between individual particles of the particulate build material, often increasing Van der Waals attractions between the particles.

The degree at which these particles have been modified by removal of the metal oxide nodules and/or other surface asperities can be quantified using cohesive index units. Cohesive index units may be measured using a propriety algorithm developed by “GranuTools” (Belgium). This measurement uses a Granudrum™, which is a rotating drum cohesion powder tester also available from GranuTools. The Granudrum™ is filled halfway with a sample of the particulate build material, and rotates around its axis at an angular velocity ranging from 2 RPM to 70 RPM and a CCD camera is used to take from 10 to 100 snapshots separated at one second between camera images taken. The images are then evaluated to determine angular velocity. In accordance with the present disclosure, a range of about 2 RPM to about 60 RPM can be used at ambient temperature (about 20° C.) and pressure (about 1 ATM), for example. An air powder interface is detected at each snapshot using an edge detection algorithm. The average interface position and fluctuations around the average position are computed. For each rotating speed, the flowing angle is computed from the average interface position. The algorithm used with this instrument determines the cohesive index units from interface fluctuations. In general, a cohesive index unit close to zero corresponds to a non-cohesive powder, and as the cohesive index units increase, the powder cohesiveness increases. In accordance with the present disclosure, the cohesive index units as described herein, e.g., about 25 to about 35, represent a balanced cohesiveness that is both low enough to provide acceptable spreadability of the particulate build material on a layer-by-layer basis and high enough to reduce incidents of powder splash that may occur when ejecting binding agent onto the particulate build material at a relatively high velocity, e.g., from about 1 m/s to about 20 m/s.

The term “fresh” when referring the fresh particulate build material refers to the metal powder as manufactured, without additional processing. If there are other particles added to the particulate build material, those added particles are also included as part of the fresh particulate build material. As an example, fresh metal particles of the particulate build material may be manufactured by spraying molten metals into a stream of cold inert gas, and collecting the resulting powder for packaging. Fresh powder manufactured in this manner may be mixed to some degree as part of the manufacturing process, but no prolonged mechanical cycling of the metal particles occurs during the manufacturing process. The term “fresh” also provides a distinguishing term to describe the particulate build material prior to and after mechanical conditioning as described herein. If metal particles are modified from an initial state having a particle size distribution outside of the D10, D50, and D90 values and/or outside of the modified cohesive index unit ranges provided, then the particulate build material, including the metal particles, can be considered to be “fresh” relative to the mechanical conditioning where these values may be achieved.

Conditioning of the fresh particulate build material can be carried out using a mechanical mixer, such as a mechanical mixer including an acoustic mixer, a convective mixer, a ribbon mixer, a tumbler mixer, a vertical mixer with a stirring mechanism, a pneumatic phase transport, a sieve, a hopper flow, and/or a tilt-table. When the mechanical mixer is of a type that includes a rotational mixing element or structure, the mixing can occur at from about 2 RPM to about 60 RPM, from about 15 RPM to about 50 RPM, from about 10 RPM to about 25 RPM, or from about 20 RPM to about 40 RMMs, for example. In some instances, other types of mixers can be used that may not be coupled with rotational devices, such as an acoustic mixer. Large batches of the fresh particulate build material, however, may be more practically mixed in some instances using a high power rotational mixer for a sufficient period of time to achieve a batch of particles that exhibits the cohesive index unit range described herein. Example time frames for mixing for these various types of mixers can range from about 2 minutes to about 8 hours, from about 5 minutes to about 8 hours, from about 10 minutes to about 4 hours, from about 30 minutes to about 4 hours, from about 30 minutes to about 2 hours, or from about 1 hour to about 4 hours. In some examples, a tumbler mixer can be used at from about 10 RPM to about 25 RPM for a period of time from about 5 minutes to about 2 hours.

The particulate build material may include up to 20 wt % of components other than metal particles. These components may be added prior to or after mechanical conditioning. For example, the particulate build material may include polymer particles, ceramic particles, and/or one or more of flow additives, antioxidants, inorganic filler, or any combination thereof. Typically, an amount of the additives, antioxidants, inorganic filer, and the like is about 5 wt % or less. Example flow additives include fumed silica. Example antioxidants include hindered phenols, phosphites, thioethers, hindered amines, or the like. Example inorganic fillers include particles such as alumina, silica, fibers, carbon nanotubes, cellulose, glass beads, glass fibers, or the like. Some additives may serve multiple functions, e.g., fumed silica may act as a flow additive and a filler.

The mechanically conditioning can include placing the fresh particulate build material into a mechanical conditioner for a period of time and applying a force until the cohesive index units of the conditioned particulate build material are reached. The mechanical conditioner may include an acoustic mixer, a convective mixer, a ribbon mixer, a tumbler mixer, a vertical mixer with a stirring mechanism such as a helical or auger-like stirrer, a pneumatic phase transport, a sieve, a hopper flow, or a tilt-table. In some examples, the mechanical conditioner includes an acoustic mixer, a convective mixer, a ribbon mixer, a tumbler mixer, or a vertical mixer with a stirring mechanism such as a helical or auger-like stirrer. A time frame for the mechanically conditioning may vary depending on the type of mixer and mixing intensity; however, in some examples the time period can range from about 5 minutes to about 4 days. The mechanically conditioning may occur at about 2 RPM to about 60 RPM for a time period ranging from about 2 minutes to about 8 hours. Mechanically conditioning in a tumbler mixer or a vertical mixer may occur at about 10 RPM to about 25 RPM or from about 20 to about 40 RPM for a time period ranging from about 5 minutes to about 120 minutes or from about 10 minutes to about 45 minutes. Mechanically conditioning on a tilt-table, on the other hand, may occur over several days, e.g., 2 to 5 days.

### Methods of Three-Dimensional Printing

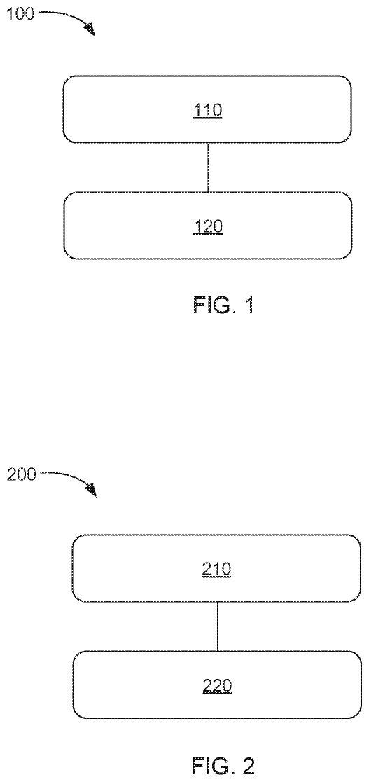

The conditioned particulate build material prepared by example in connection with FIG. 1 may be used in methods of three-dimensional printing to form a three-dimensional object, e.g., green body objects that are heat fused to form fused metal objects. As illustrated in FIG. 2, example methods 200 of printing three-dimensional objects include iteratively applying 210 the conditioned particulate build material as individual build material layers to a powder bed (of the conditioned particulate build material), and based on a 3D object model, selectively and iteratively applying 220 a binding agent onto individual conditioned build material layers of the particulate build material to build up and bind the layers together. This results in the formation of a three-dimensional green body object carried within loose powder of the powder bed. In printing the green body object in a layer-by-layer manner, the conditioned build material is spread, the binding agent applied, and this is repeated for as many layers as may be used to form the green body object. The individual layer thicknesses applied to the build platform can be from about 20 μm to about 1 mm, from about 50 μm to about 800 μm, or from about 50 μm to about 500 μm, and thus, a build platform can be dropped a corresponding thickness for each printed layer. In some instances during the build, individual layers or multiple layers of the green body object may be exposed to heat to drive off liquid vehicle components from the printed binding agent and/or exposed to heat or electromagnetic energy to activate the binder in the binding agent.

The three-dimensional green body object can be subsequently separated from the powder bed and then heat fused, such as by sintering the green body object, at an elevated temperature of from about 500° C. to about 3,500° C. Heat fusion causes the metal particles of the green body object to fuse to one another and form the fused metal three-dimensional object. In some examples, the heat fusing may occur at a temperature ranging from about 1,000° C. to about 3,000° C., from about 1,500° C. to about 2,500° C., or from about 800° C. to about 1800° C. to form the heat fused three-dimensional object. This may depend on the particle size, the degree of particle melting or sintering desired, and the metal particles selected for use. In some examples, heat fusing may occur in ambient air, or alternatively, in a controlled gas atmosphere that is other than ambient air. Various pressures may also be used, ranging from vacuum pressure to positive pressure. As an example, the controlled atmosphere may include vacuum pressure and/or may include a gas atmosphere other than air, or both. The gas atmosphere may be selected to include (or be) at least one of argon, argon-hydrogen mixture, diazene, helium, hydrogen, nitrogen, and/or nitrogen-hydrogen mixture. In some examples, the fusing oven can be a vacuum sintering oven where a gas atmosphere is pumped in multiple times to minimize or eliminate an oxygen content therein. The use of a controlled atmosphere, in some instances, may minimize oxidation of metal particles during fusing of the metal particles and improve an overall strength of the fused three-dimensional object.

As the particulate build material used to form the green body object includes the conditioned metal particles, the conditioned metal particles are what will be fused together (along with other additives or particles that may or may not also be present) to form the fused metal object. When using conditioned particulate build material as described, in some examples, the fused metal three-dimensional object may have a theoretical density and/or strength that is greater than when unconditioned metal particles are used. In some instances, the theoretical density of the fused metal object can be from about 85% to 100%, from about 85% to about 95%, or from about 90% to about 100%. The theoretical density may be increased because the particles can become more tightly packed during the build within the powder bed. This may be because the individual conditioned metal particles have fewer or smaller sized metal oxide nodules and/or other surface asperities compared to unconditioned metal particles. “Theoretical density” is defined herein to correspond to the theoretical metal particle density were it to include no voids. As an example, 100% theoretical density means that the fused three-dimensional object has the same density as the bulk material used in the powder bed.

In other examples, overall strength of the three-dimensional object formed can increase compared to identically prepared fused metal objects prepared with the unconditioned metal particles. For example, the fused metal three-dimensional object may have an elongation at break that is greater than a corresponding elongation at break of a comparable three-dimensional printed object formed identically, except that the comparable three-dimensional object is prepared from the fresh particulate build material rather than the conditioned particulate build material.

### Systems for Three-Dimensional Printing

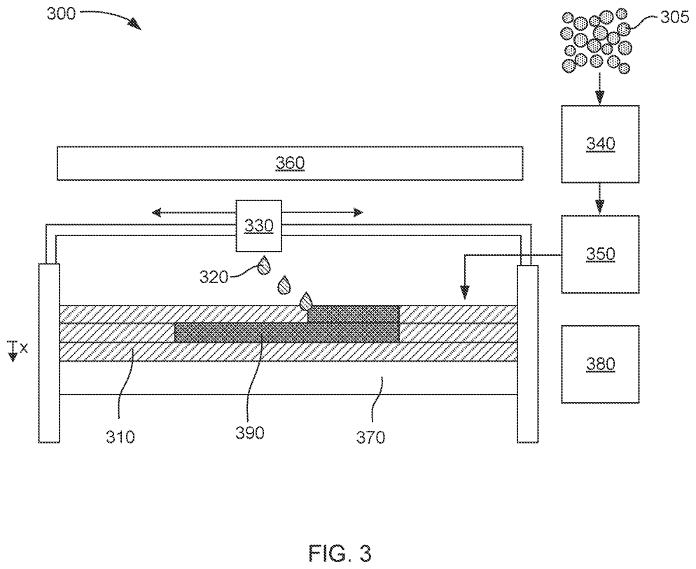

Systems for three-dimensional printing 300, as shown in FIG. 3, can be used in connection with the methods described by way of example in FIGS. 1 and 2 and the three-dimensional printing kits described hereinafter. For example, systems for three-dimensional printing include conditioned particulate build material 310 with from 80 wt % to 100 wt % conditioned metal particles having a cohesive index ranging from about 25 cohesive index units to about 35 cohesive index units, or any of the weight percentage ranges and/or subranges also described previously. The system also includes a printhead 330 fluidly coupled to or fluidly coupleable to a binding agent 320 to selectively and iteratively eject the binding agent onto successively applied individual layers of conditioned particulate build material. In some examples, the system also includes a mechanical mixer 340 to receive and condition fresh particulate build material 305 to form the conditioned particulate build material, which includes the conditioned metal particles. The conditioned particulate build material may be iteratively applied to a build platform 370 or a powder bed with previously deposited layers of conditioned particulate build material (which may include binding agent printed portions) that is positioned to permit application of the binding agent from the printhead onto a layer of the conditioned particulate build material. The build platform can be configured to drop in height at a distance (x) corresponding with the thickness of the build material layer applied, thus allowing for successive layers of conditioned particulate build material to be applied by a supply and/or spreader 350. The supply/spreader can be a single unit or multiple units used in series. The mechanical mixer may be integrated with the supply and/or spreader in some examples.

In further detail, the mechanical mixer 340 receives and conditions the fresh particulate build material to form a conditioned particulate build material including conditioned metal particles. The mechanical mixer used can be an acoustic mixer, a convective mixer, a ribbon mixer, a tumbler mixer, a vertical mixer with a stirring mechanism, a pneumatic phase transport, a sieve, a hopper flow, and/or a tilt-table, for example.

The printhead 330 may be a fluid ejector operable to selectively deposit jettable fluid(s), such as the binding agent 320 onto the particulate build material to form individually patterned green body object layers 390. Fluid ejector(s) can be any type of printing apparatus capable of selectively applying the binding agent or any other fluid agent that may be used. For example, the printhead may be a fluid ejector or digital fluid ejector, such as an inkjet printhead, e.g., a piezo-electric printhead, a thermal printhead, or a continuous printhead, or may be another type of applicator such as a sprayer, a dropper, etc. Thus, in some examples, the application may be by jetting or ejecting the binding agent from a digital fluidjet applicator. The printhead may be located on a carriage track or could be static along one or multiple axes.

Upon selective application of a binding agent 320, the conditioned particulate build material 310 may be exposed to heat from the radiant heat source 360. The radiant heat source can be an infrared (IR) or near-infrared light source, such as IR or near-IR curing lamps, IR or near-IR light emitting diodes (LED), or lasers with the desirable IR or near-IR electromagnetic wavelengths, which emit radiation having a wavelength ranging from about 340 nm to about 1 mm. In some examples, the radiant heat source may be operatively connected to a lamp/laser driver, an input/output temperature controller, and/or temperature sensors.

In examples that use a radiant heat source 360, it may be positioned or positionable to expose the individual layers of the conditioned particulate build material to heat at a temperature suitable for forming the green body object so that the green body object is stable enough to move to a heat fusing oven 380. Heat application to the green body object in the powder bed may be used to partially reduce a metal binder and/or partially melt or melt polymer binder. Either way, the binding agent, with or without application of heat in the powder bed, is formulated in conjunction with the system to cause the conditioned metal particles to adhere to particles of the conditioned particulate build material to bind together. On the other hand, the temperature used in the heat fusing oven may be a much higher temperature as previously described, which is sufficient to cause the conditioned metal particles to become heat fused or sintered together.

### Three-Dimensional Printing Kits

Three-dimensional printing kits that can be used or prepared in accordance with the systems and methods herein include conditioned particulate build material including from 80 wt % to 100 wt % conditioned metal particles, with the conditioned particulate build material having a cohesive index ranging from about 25 cohesive index units to about 35 cohesive index units. The three-dimensional printing kit also includes an aqueous liquid vehicle and a binder. The conditioned particulate build material can be or include any of the materials, ranges, and/or physical property details described previously. For example, the conditioned metal particles may include gas atomized spherical stainless steel particles in some examples, or may include other metals or alloys, have other morphologies, or be prepared initially by other methods. In other examples, the binding agent can be stable at 25° C. and can include at least one of a polymer binder, a polymerizable binder, or thermally reducible metal salt or metal oxide nanoparticles in the presence of a reducing compound. The conditioned particulate build material may be packaged or co-packaged with the binding agent in separate containers, and/or may be combined at the time of printing, e.g., loaded together in a three-dimensional printing system.

In further detail regarding the binding agent, a binder is carried by a liquid vehicle, such as an aqueous liquid vehicle, that can be jetted or ejected from a printhead. During three-dimensional printing, the aqueous liquid vehicle is capable of wetting a particulate build material and the binder moves into vacant spaces between particles of the particulate build material. The binding agent may provide binding to the particulate build material upon application, or in some instances, may be activated after application to provide binding. The binder may be activated or cured by heating the binder (which may be accomplished by heating an entire layer of the particulate build material on a portion of the binding agent which has been selectively applied). The term “binder” includes any material used to physically bind separate particles of the particulate build material together or facilitate adhesion to a surface of adjacent particles of the particulate build material when preparing a green body object. In some examples, the binder includes metal binders and/or polymer or polymerizable binders.

With specific reference to metal binders, the metal may in the form of metal salt or metal oxide nanoparticles that are thermally reducible to a metal or metal alloy at an elevated reducing temperature. The metal or metal alloy can be in the form of a reducible-metal compound binder. The reducible-metal compound binder may include aluminum oxide, cerium oxide, chromium oxide, copper oxide, iron oxide, lanthanum oxide, magnesium oxide, manganese oxide, niobium oxide, silicon dioxide, silver oxide, tin oxide, titanium oxide, yttrium oxide, zinc oxide, zirconium dioxide, salts thereof, or mixtures thereof. Due to variable oxidation states of transition metals, various oxides may be formed. Other examples of metal binders may include organic or inorganic metal salts such as metal bromides, metal chlorides, metal nitrates, metal sulfates, metal nitrites, metal carbonates, or a combination thereof. Example organic metal salts include chromic acid, chrome sulfate, cobalt sulfate, potassium gold cyanide, potassium silver cyanide, copper cyanide, copper nitrate, copper sulfate, nickel carbonate, nickel chloride, nickel fluoride, nickel nitrate, nickel sulfate, potassium hexahydroxy stannate, sodium hexahydroxy stannate, silver cyanide, silver ethansulfonate, silver nitrate, sodium zincate, stannous chloride (or tin(II) chloride), stannous sulfate (or tin(II) sulfate, zinc chloride, zinc cyanide, or tin methansulfonate.

Particles of a metal binder may have a D50 particle size ranging from about 10 nm to about 10 μm, from about 10 nm to about 5 μm, from about 10 nm to about 1 μm, from about 15 nm to about 750 nm, or from about 20 nm to about 400 nm. The metal binder may be present in a binding agent at from about 20 wt % to about 65 wt %, from about 30 wt % to about 50 wt %, from about 40 wt % to about 60 wt %, or from about 20 wt % to about 60 wt %.

Metal binder may be reduced by an introduced atmosphere with a reducing agent and/or may be thermally reduced. Reducing agents for the metal binder may include hydrogen (H₂), lithium aluminum hydride, sodium borohydride, borane (e.g., diborane, catecholborane, etc.) sodium hydrosulfite, hydrazine, hindered amine, 2-pyrrolidone, ascorbic acid, reducing sugar (e.g., a monosaccharide), diisobutylaluminium hydride, formic acid, formaldehyde, or mixtures thereof. Thermal reducing may involve application of heat, e.g., from 200° C. to 1000° C. or from 250° C. to 1000° C. or from 300° C. to 700° C., to a metal oxide stable (or relatively unreactive) at room temperature. Upon a redox-reaction the metal oxide may form a pure metal or metal alloy. As an example, mercury oxide or silver oxide can be reduced to their respective elemental metal by heating to about 300° C., but the presence of a reducing agent may allow the reaction to occur at a lower temperature, e.g., about 180° C. to about 200° C. Oxides of more reactive metals like zinc, iron, copper, nickel, tin, or lead may likewise be reduced simply in the presence of a reducing agent. The metal salt or oxide nanoparticles can be present in the binding agent at from about 20 wt % to about 65 wt %, from about 30 wt % to about 50 wt %, from about 40 wt % to about 60 wt %, or from about 20 wt % to about 60 wt %.

In other examples, the binder may be a polymer or polymerizable binder. The polymer binder or polymerizable binder may have different morphologies and may include a uniform composition, e.g., a single monomer mixture, or two different compositions, e.g., multiple monomer compositions, copolymer compositions, or a combination thereof, which may be fully separated core-shell polymers, partially occluded mixtures, or intimately comingled as a polymer solution.

In some examples, the polymer binder or polymerizable binder includes latex particles. The latex particles may include 2, 3, 4 or more relatively large polymer particles attached to one another. In a further example, the latex particles have single phase morphology that may be partially occluded, multiple-lobed, or a combination of any of the morphologies disclosed herein. The latex particles may include polymerized monomers of vinyl, vinyl chloride, vinylidene chloride, vinyl ester, functional vinyl monomers, acrylate, acrylic, acrylic acid, hydroxyethyl acrylate, methacrylate, methacrylic acid, styrene, substituted methyl styrenes, ethylene, maleate esters, fumarate esters, itaconate esters, α-methyl styrene, p-methyl styrene, methyl (meth)acrylate, hexyl acrylate, hexyl (meth)acrylate, butyl acrylate, butyl (meth)acrylate, ethyl acrylate, ethyl (meth)acrylate, propyl acrylate, propyl (meth)acrylate, 2-ethylhexyl acrylate, 2-ethylhexyl (meth)acrylate, isodecyl (meth) acrylate, octadecyl acrylate, octadecyl (meth)acrylate, stearyl (meth)acrylate, vinylbenzyl chloride, isobornyl acrylate, isobornyl (meth)acrylate, tetrahydrofurfuryl acrylate, tetrahydrofurfuryl (meth)acrylate, 2-phenoxyethyl (meth)acrylate, benzyl (meth)acrylate, benzyl acrylate, ethoxylated nonyl phenol (meth)acrylate, isobornyl (meth)acrylate, cyclohexyl (meth)acrylate, trimethyl cyclohexyl (meth)acrylate, t-butyl (meth)acrylate, n-octyl (meth)acrylate, lauryl (meth)acrylate, tridecyl (meth)acrylate, alkoxylated tetrahydrofurfuryl acrylate, alkoxylated tetrahydrofurfuryl (meth)acrylate, isodecyl acrylate, isobornyl methacrylate, isobornyl acrylate, dimethyl maleate, dioctyl maleate, acetoacetoxyethyl (meth)acrylate, diacetone acrylamide, diacetone (meth)acrylamide, N-vinyl imidazole, N-vinylcarbazole, N-vinyl-caprolactam, combinations thereof, derivatives thereof, or mixtures thereof. In other examples, the latex particles may include acidic monomers such as acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, sodium 1-allyloxy-2-hydroxypropane sulfonate, combinations thereof, derivatives thereof, or mixtures thereof. In some examples, the latex is selected from acrylate-containing latex, methacrylate-containing latex, styrene-containing latex, polyurethane latex, or a mixture thereof.

The polymer or polymerizable binder can have various molecular weights, sizes, glass transition temperatures, etc. The polymer may have a weight average molecular weight ranging from about 10,000 Mw to about 500,000 Mw, from about 100,000 Mw to about 500,000 Mw, or from about 150,000 Mw to about 300,000 Mw. The polymer may have a particle size that can be jetted via thermal ejection or printing, piezoelectric ejection or printing, drop-on-demand ejection or printing, continuous ejection or printing, etc. In an example, the particle size of particles of the polymer can range from about 10 nm to about 400 nm, from about 10 nm to about 300 nm, from about 50 nm to about 250 nm, from about 100 nm to about 300 nm, or from about 25 nm to about 250 nm. The polymer may have a glass transition temperature that ranges from about −20° C. to about 130° C., from about 60° C. to about 105° C., or from about 10° C. to about 110° C. A polymer binder can be present in the binding agent at from about 5 wt % to about 30 wt %, from about 10 wt % to about 20 wt %, from about 20 wt % to about 30 wt %, from about 12 wt % to about 16 wt %, or from about 15 wt % to about 25 wt %.

As used herein, the term “liquid vehicle” refers to the liquid used to carry the binding agent. The liquid vehicle may include water for an aqueous liquid vehicle. If water is present, it may be deionized. The water may be present at a weight percentage that may vary from about 30 wt % to about 90 wt %, from about 50 wt % to about 80 wt %, or from about 70 wt % to about 90 wt %. The liquid vehicle can also or alternatively include a variety of additional components, such as organic co-solvent, surfactant, buffer, antimicrobial agent, anti-kogation agent, chelating agent, buffer, etc. In some examples, the liquid vehicle includes water and organic co-solvent. In other examples, the liquid vehicle includes water, organic co-solvent, and a surfactant. In other examples, the aqueous liquid vehicle includes water, organic co-solvent, surfactant, and antimicrobial agent. In other examples, the aqueous liquid vehicle includes water, organic co-solvent, surfactant, antimicrobial agent, and a chelating agent.

Some examples of organic co-solvent(s) may include ethanol, methanol, propanol, acetone, tetrahydrofuran, hexane, 1-butanol, 2-butanol, tert-butanol, isopropanol, propylene glycol, triethylene glycol, methyl ethyl ketone, dimethylformamide, 1,4-dioxone, acetonitrile, 1,2-butanediol, 1-methyl-2,3-propanediol, 2-pyrrolidone, glycerol, 2-phenoxyethanol, 2-phenylethanol, 3-phenylpropanol, or a combination thereof. In other examples, the organic co-solvent may include 2-pyrrolidonone. Whether a single co-solvent is included or a combination of co-solvents are included, a total amount of organic co-solvent(s) in the binding agent may range from about 5 wt % to about 50 wt %, from about 10 wt % to about 50 wt %, from about 15 wt % to about 45 wt %, from about 30 wt % to about 50 wt %, from about 5 wt % to about 35 wt %, or from about 5 wt % to about 40 wt %, based on a total weight percentage of the binding agent.

Examples of surfactants may include a non-ionic surfactant, a cationic surfactant, and/or an anionic surfactant. Example non-ionic surfactants may include self-emulsifiable, nonionic wetting agents based on acetylenic diol chemistry (e.g., SURFYNOL® SEF from Air Products and Chemicals, Inc., USA), a fluorosurfactant (e.g., CAPSTONE® fluorosurfactants from DuPont, USA), or a combination thereof. In other examples, the surfactant may be an ethoxylated low-foam wetting agent (e.g., SURFYNOL® 440, SURFYNOL® 465, or SURFYNOL® CT-111 from Air Products and Chemical Inc., USA) or an ethoxylated wetting agent and molecular defoamer (e.g., SURFYNOL® 420 from Air Products and Chemical Inc., USA). Still other surfactants may include wetting agents and molecular defoamers (e.g., SURFYNOL® 104E from Air Products and Chemical Inc., USA), alkylphenylethoxylates, solvent-free surfactant blends (e.g., SURFYNOL® CT-211 from Air Products and Chemicals, Inc., USA), water-soluble surfactant (e.g., TERGITOL® TMN-6, TERGITOL® 15S7, and TERGITOL® 15S9 from The Dow Chemical Company, USA), or a combination thereof. In other examples, the surfactant may include a non-ionic organic surfactant (e.g., TEGO® Wet 510 from Evonik Industries AG, Germany), a non-ionic secondary alcohol ethoxylate (e.g., TERGITOL® 15-S-5, TERGITOL® 15-S-7, TERGITOL® 15-S-9, and TERGITOL″ 15-S-30 all from Dow Chemical Company, USA), or a combination thereof. Example anionic surfactants may include alkyldiphenyloxide disulfonate (e.g., DOWFAX® 8390 and DOWFAX® 2A1 from The Dow Chemical Company, USA), and oleth-3 phosphate surfactant (e.g., CRODAFOS™ N3 Acid and CRODAFOS™ 03A both from Croda, UK). Example cationic surfactants may include dodecyltrimethylammonium chloride, hexadecyldimethylammonium chloride, or a combination thereof. In some examples, the surfactant (which may be a blend of multiple surfactants) may be present in the binding agent at an amount ranging from about 0.01 wt % to about 2 wt %, from about 0.05 wt % to about 1.5 wt %, or from about 1 wt % to about 2 wt %.

In some examples, the liquid vehicle may include a chelating agent, an antimicrobial agent, a buffer, or a combination thereof. While the amount of these may vary, if present, these may be present at a total amount ranging from about 0.001 wt % to about 20 wt %, from about 0.05 wt % to about 10 wt %, or from about 0.1 wt % to about 5 wt % in the binding agent. Examples of suitable chelating agents include disodium ethylene-diaminetetraacetic acid (EDTA-Na), ethylene diamine tetra acetic acid (EDTA), and methyl-glycinediacetic acid (e.g., TRILON® M from BASF Corp., Germany). If included, whether a single chelating agent is used or a combination of chelating agents is used, the total amount of chelating agent(s) in the binding agent may range from 0.01 wt % to about 2 wt % or from about 0.01 wt % to about 0.5 wt %.

Example antimicrobial agents include NUOSEPT® (Ashland Inc., USA), VANCIDE® (R.T. Vanderbilt Co., USA), ACTICIDE® B20 and ACTICIDE® M20 (Thor Chemicals, U.K.), PROXEL® GXL (Arch Chemicals, Inc., USA), BARDAC® 2250, 2280, BARQUAT® 50-65B, and CARBOQUAT® 250-T, (Lonza Ltd. Corp., Switzerland), KORDEK® MLX (The Dow Chemical Co., USA), and combinations thereof. In some examples a total amount of antimicrobial agents in the binding agents may range from about 0.01 wt % to about 1 wt %.

A buffer solution(s) may be present in the aqueous liquid vehicle which can withstand small changes (e.g., less than 1) in pH. The buffer solution(s) can have pH ranges from about 5 to about 9.5, from about 7 to about 9, or from about 7.5 to about 8.5. In some examples, the buffer solution(s) may include a poly-hydroxy functional amine, potassium hydroxide, 2-[4-(2-hydroxyethyl) piperazin-1-yl] ethane sulfonic acid, 2-amino-2-(hydroxymethyl)-1,3-propanediol (TRIZMA® sold by Sigma-Aldrich, USA), 3-morpholinopropanesulfonic acid, triethanolamine, 2-[bis-(2-hydroxyethyl)-amino]-2-hydroxymethyl propane-1,3-diol (bis tris methane), N-methyl-D-glucamine, N,N,N′N′-tetrakis-(2-hydroxyethyl)-ethylenediamine and N,N,N′N′-tetrakis-(2-hydroxypropyl)-ethylenediamine, beta-alanine, betaine, or mixtures thereof. In other examples, the buffer solution(s) may include 2-amino-2-(hydroxymethyl)-1,3-propanediol (TRIZMA® sold by Sigma-Aldrich, USA), beta-alanine, betaine, or mixtures thereof. The buffer solution may be added to the binding agent at an amount ranging from about 0.01 wt % to about 10 wt %, from about 0.1 wt % to about 7.5 wt %, or from about 0.05 wt % to about 5 wt %.

### Definitions

Terms used herein will have the ordinary meaning in their technical field unless specified otherwise. In some instances, there are terms defined more specifically throughout the specification or in this section of the present specification, and thus, these terms can have a meaning as described herein.

When discussing the methods of preparing the particulate build material for three-dimensional printing, method of three-dimensional printing, three-dimensional printing kits, and/or systems for three-dimensional printing herein, these discussions can be considered applicable to one another whether or not they are explicitly discussed in the context of that example. Thus, for example, when discussing metal particles related to methods of preparing the particulate build material for three-dimensional printing, such disclosure is also relevant to and directly supported in the context of the three-dimensional printing methods, three-dimensional printing kits, systems for three-dimensional printing, and/or vice versa.

It is noted that, as used in this specification and the appended claims, the singular forms “a.” “an.” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of multiple components where the different components can be separately contained (though in some instances co-packaged in separate containers) prior to use, but these components can be combined together during use, such as during the three-dimensional object build processes described herein. The containers can be any type of a vessel, box, or receptacle made of any material.

As used herein, “applying” when referring to fluid agent, such as a binding agent, refers to any technology that can be used to put or place the fluid, e.g., binding agent, on the particulate build material or into a layer of particulate build material for forming a three-dimensional object. For example, “applying” may refer to a variety of dispensing technologies, including “jetting,” “ejecting,” “dropping,” “spraying,” or the like.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, a plurality of items, structural elements, compositional elements, and/or materials may be presented in a common list for convenience. However, these lists should be construed as though an individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. Numerous modifications and alternative compositions, methods, and systems may be devised without departing from the present disclosure. The appended claims are intended to cover such modifications and arrangements.

### Example 1—Metal Particle Conditioning

316L stainless steel particles were viewed using a high resolution scanning electron microscope at 50,000 times magnification using a Camsizer™ X2 from Microtrac MRB (Japan) as the optical image analysis tool. The D50 particle size was about 20-25 μm, with a D10 particle size from about 2-10 μm and a D90 particle size from about 20-40 μm. The particles had a goose bump like appearance from oxide nodules on its surface. The particles were mechanically conditioned in a Resodyn LabRAM II acoustic mixer for 5 minutes at 100 g acceleration and viewed again under the high resolution scanning electron microscope at 50,000 times magnification. The oxide nodules causing the goose bump like appearance were diminished or no longer visible and the surface of the particles was visibly smooth.

Fresh particles and the conditioned metal particles were then individually tested for powder cohesitivity. The cohesive index was measured using a Granudrum™ from GranuTools. The Granudrum™ was rotated at a speed between 20 RPM and 40 RPM. The cohesive index units were determined using GranuTools proprietary algorithm. The fresh particles had a cohesive index value between 10 and 20 cohesive index units. The conditioned metal particles had a cohesive index value between 25 and 35 cohesive index units. This modification in cohesive index resulted in acceptable powder spreading behavior while reducing the propensity for powder splash when high velocity droplets of binding agent were applied to the conditioned particulate build material.

### Example 2—Three-Dimensional Printing

The conditioned metal particles and fresh metal particles from Example 1 were respectively used as individual build materials in a method of three-dimensional printing to produce several dog bone (or barbell) shaped three-dimensional objects. The powder bed of the particulate build material was held at an elevated temperature of about 165° C. and a binding agent having the formulation in Table 1 below was printed at a fluid density which corresponded to about 5 wt % of a binding agent (0.8 wt % polymer content) and about 95 wt % particulate build material per layer.

TABLE 1
Binding Agent Formulation

| Component | (wt %) |
|---|---|
| Surfactant | 0.9 |
| Latex Binder (by solids content) | 16 |
| Colorant | 0.4 |
| 1,2-Butanediol | 12 |
| Deionized Water | Balance |

The particulate build material with the binding agent printed thereon heated during printing until green body objects were formed, which were transferred to a fusing oven and sintered. The oven was heated at 3° C. per minute up to a temperature of 1,000° C. and baked in the oven for 2 hours followed by furnace cooling.

### Example 3—Elongation at Break-Strain Testing

The three-dimensional printed objects from Example 2 were analyzed with an INSTRON® tensiometer to evaluate changes in elongation at break in the XY-direction. All of the three-dimensional printed objects formed with the conditioned build material exhibited an increase in elongation at break in the XY-direction or orientation when compared with the three-dimensional printed objects formed from the fresh particulate build material. The examples above indicate that conditioned particulate build material having fewer surface asperities and three-dimensional objects formed therefrom can have improved elasticity and strength.

What is claimed is:

1. A method of preparing particulate build material for three-dimensional printing, comprising:
loading fresh particulate build material including from about 80 wt % to 100 wt % fresh metal particles into a mechanical mixer, wherein the fresh metal particles include a surface oxide layer, and wherein the fresh metal particles have a particle size distribution a D10 particle size from about 2 μm to about 10 μm, a D50 particle size from about 5 μm to about 20 μm, and a D90 particle size from about 20 μm to about 40 μm; and
mechanically conditioning the fresh particulate build material to generate conditioned particulate build material including conditioned metal particles, wherein the conditioned particulate build material has a modified cohesive index ranging from about 25 cohesive index units to about 35 cohesive index units.

2. The method of claim 1, wherein the metal particles include at least one of an elemental metal or alloy of iron, chromium, nickel, titanium, steel, stainless steel, carbon steel, cast iron, or wrought iron.

3. The method of claim 1, wherein the fresh metal particles are gas atomized spherical particles.

4. The method of claim 1, wherein mechanically conditioning occurs using at least one of an acoustic mixer, a convective mixer, a ribbon mixer, a tumbler mixer, a vertical mixer with a stirring mechanism, a pneumatic phase transport, a sieve, a hopper flow, or a tilt-table.

5. The method of claim 1, wherein mechanically conditioning occurs at about 2 RPM to about 60 RPM for a time period ranging from about 2 minutes to about 8 hours.

6. The method of claim 1, wherein mechanically conditioning occurs in the tumbler mixer or a vertical mixer at from about 10 RPM to about 25 RPM for a time period ranging from about 5 minutes to about 2 hours.

7. A method of printing a three-dimensional object, comprising:
iteratively applying the conditioned particulate build material of claim 1 as individual build material layers to a powder bed; and
based on a 3D object model, selectively and iteratively applying a binding agent onto individual conditioned build material layers of the particulate build material to build up and bind the layers together to form a three-dimensional green body object.

8. The method of claim 7, further comprising sintering the three-dimensional green body object at an elevated temperature of from about 500° C. to about 3,500° C. to fuse the metal particles to one another and form a fused metal three-dimensional object.

9. The method of claim 8, wherein the fused metal three-dimensional object has a theoretical density from about 85% to 100%.

10. The method of claim 8, wherein the fused metal three-dimensional object has an elongation at break that is greater than a corresponding elongation at break of a comparable three-dimensional printed object formed identically except that the comparable three-dimensional object is prepared from the fresh particulate build material rather than the conditioned particulate build material.

11. A three-dimensional printing kit, comprising:
a conditioned particulate build material including from 80 wt % to 100 wt % conditioned metal particles, wherein the conditioned particulate build material has a cohesive index ranging from about 25 cohesive index units to about 35 cohesive index units; and
a binding agent including an aqueous liquid vehicle and a binder.

12. The three-dimensional printing kit of 11, wherein the conditioned metal particles include gas atomized spherical stainless steel particles.

13. The three-dimensional printing kit of claim 11, wherein the binding agent is stable at 25° C., and the binder includes at least one of a polymer binder, a polymerizable binder, or thermally reducible metal salt or metal oxide nanoparticles in the presence of a reducing compound.

14. A system for three-dimensional printing, comprising:
a conditioned particulate build material including from 80 wt % to 100 wt % conditioned metal particles having a cohesive index ranging from about 25 cohesive index units to about 35 cohesive index units; and
a printhead fluidly coupled to or fluidly coupleable to a binding agent to selectively and iteratively eject the binding agent onto successive applied individual layers of conditioned particulate build material.

15. The system of claim 14, further comprising a mechanical mixer to receive and condition fresh particulate build material to form the conditioned particulate build material including conditioned metal particles.
